(19) United States
(12) Patent Application Publication
(10) Pub. No.: US 2021/0110386 A1
(43) Pub. Date: Apr. 15, 2021

(54) SYSTEM AND METHOD FOR UNIVERSAL ASSET TOKENS

(71) Applicant: Coinbase, Inc., San Francisco, CA (US)

(72) Inventors: Jonas Meyer, San Francisco, CA (US); Katherine Cook, San Francisco, CA (US)

(21) Appl. No.: 17/071,887

(22) Filed: Oct. 15, 2020

Related U.S. Application Data
(60) Provisional application No. 62/915,173, filed on Oct. 15, 2019.
(60) Provisional application No. 62/992,040, filed on Mar. 19, 2020.

(51) Int. Cl. G06Q 20/36; G06Q 20/40; H04L 9/06; G06Q 40/04

(52) U.S. Cl. CPC G06Q 20/3678; G06Q 20/3674; H04L 2209/38; H04L 9/0643; G06Q 40/04; G06Q 20/401

(57) ABSTRACT

System and method for creating, buying, and selling universal asset tokens that represent one or more assets.

### CROSS-REFERENCE TO RELATED APPLICATIONS

This application claims priority to U.S. Provisional Application No. 62/915,173, filed 15 Oct. 2019, and U.S. Provisional Application No. 62/992,040, filed 19 Mar. 2020, which are each incorporated herein in its entirety by this reference.

### TECHNICAL FIELD

This invention relates generally to the cryptocurrency field, and more specifically to a new and useful system and method for managing assets using cryptocurrency.

### BACKGROUND

There is a need in the computer networking field to create new and useful systems and methods for managing assets using blockchains. This disclosure provides such new and useful systems and methods.

### BRIEF DESCRIPTION OF THE FIGURES

FIGS. 1A-B are schematic representations of a system, in accordance with variations.

FIG. 2A is a representation of a method, in accordance with variations.

FIG. 2B is a representation of creating a universal access token (UAT), in accordance with variations.

FIG. 2C is a representation of processing a buy request for a UAT, in accordance with variations.

FIG. 2D is a representation of processing a subsequent buy request for a UAT, in accordance with variations.

FIG. 3A is a representation of processing a buy request, in accordance with variations.

FIG. 3B is a representation of processing a sell request, in accordance with variations.

FIG. 3C is a representation of processing a subsequent buy request, in accordance with variations.

FIG. 4 is a schematic representation of an example processing a buy request by using the system, in accordance with variations.

FIG. 5 is a schematic representation of an example of minting the UAT and example UAT transactions, in accordance with variations.

FIG. 6 is a schematic representation of redeeming the UAT, in accordance with variations.

FIG. 7 is an illustrative example of a UAT, associated UAT set, and respective UAT asset sets.

### DESCRIPTION OF THE PREFERRED EMBODIMENTS

The following description of embodiments is not intended to limit the claims to these embodiments, but rather to enable any person skilled in the art to make and use embodiments described herein.

### 1. Overview.

A system and method are provided for managing assets by using digital representations (Universal Asset Tokens) of such assets.

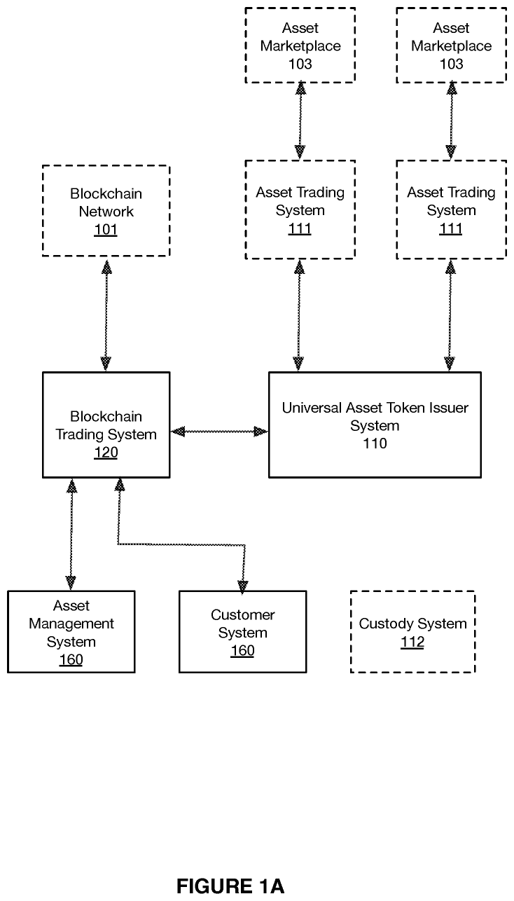

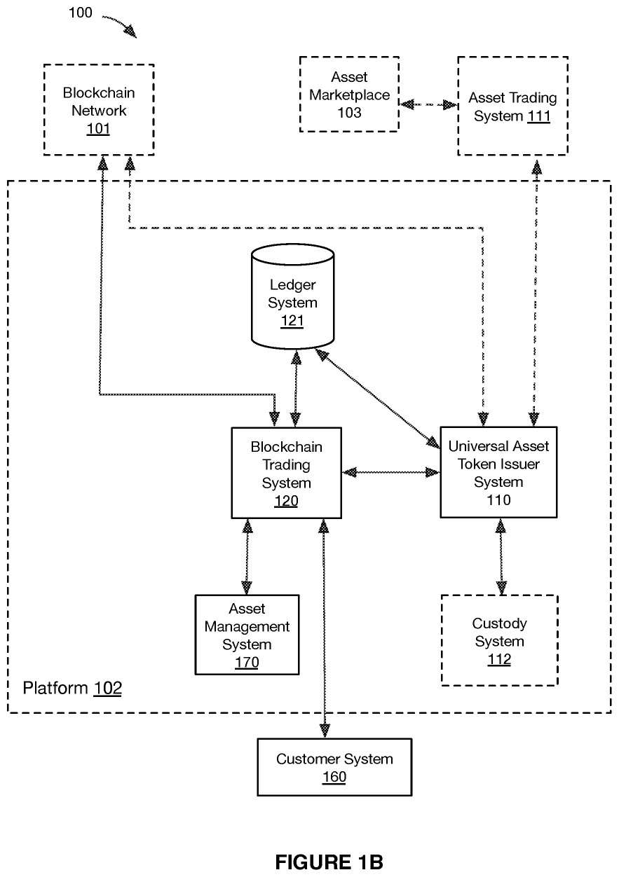

The system (e.g., 100 shown in FIGS. 1A-C) preferably includes at least one of a Universal Asset Token (UAT) issuer system (e.g., 110) and a blockchain trading system (e.g., 120). The UAT issuer system issues UATs, which represent one or more assets, and the trading system enables trading of such UATs using a distributed ledger system (e.g., a blockchain network) or any other suitable type of ledger system.

The method preferably functions to process UAT requests (e.g., “buy”, “sell”, “redeem”, etc.) related to one or more UATs. In variants, the method includes one or more of: creating a UAT; and processing at least one request for the UAT.

In some variations, “sell” requests and subsequent “buy” requests can be performed to implement tax loss harvesting, wherein a UAT that has realized a loss is sold (to recognize the loss as a tax loss) and “repurchased” to continue receiving benefits of ownership of the asset. In some variations, the system enables tax loss harvesting at arbitrary intervals, while still maintaining compliance with tax harvesting regulations (e.g., regulations that treat a sell and subsequent buy transaction within 30 days as a wash, wherein any losses realized on the sale are not recognized for tax purposes). In such variations, recognizable tax loss harvesting is enabled by determining sub-tokens for the UAT that are each backed by a different set of correlated assets and having similar market characteristics (e.g., having similar market exposure), and buying and selling the sub-tokens of the UAT, rather than trading a UAT backed by a single asset.

### 2. Benefits.

This method can confer several benefits over conventional systems and methods.

First, by virtue of using universal access tokens, any type of asset can be purchased and traded using a blockchain network.

Second, variants of the system and method create and, optionally, use, substantially dissimilar assets with similar market characteristics: the UAT sub-tokens. Because the UAT sub-tokens are substantially dissimilar but have similar market characteristics, UAT sub-token trading can maintain a user's market exposure while avoiding the wash rule. This can enable asset trading without an understanding of a user's holistic investment profile, asset trading without an understanding of the unique characteristics/preferences of the user's profile, asset trading at arbitrary intervals, tax loss harvesting, and/or other processes. This is possible by creating different UAT sub-tokens for a same asset class, primary asset, index, or other market metric. Each UAT sub-token's similarity or dissimilarity from another UAT sub-token is defined by the underlying assets that back each UAT sub-token. By selecting different underlying asset sets (e.g., varying in asset composition, asset percentage, share class, etc.) for each UAT sub-token, different UAT sub-tokens tracking the same primary asset can be made dissimilar from the primary asset and/or each other (e.g., not “substantially identical”), such that purchase of one UAT sub-token and sale of another UAT sub-token (each tracking the same primary asset) within the same 30-day period does not qualify as a wash sale. Selecting secondary assets to include in each UAT sub-token with market movements that are highly correlated with the primary asset can further reinforce this exposure.

3 Asset token.

The system and method can interact with Universal Asset Tokens (UATs).

A UAT is preferably a user abstraction, and is preferably associated with a UAT set, which can include one or more UAT sub-tokens. All UAT sub-tokens within the UAT set preferably have similar market characteristics (e.g., price movement, risk exposure, correlation with a primary asset or metric, etc.) to each other, but can alternatively have different market characteristics.

The UAT set preferably includes at least two different UAT sub-tokens, but can alternatively only include one (e.g., wherein the UAT set can be related to a second UAT set that is substantially different but shares similar characteristics). The number of UAT sub-tokens within the UAT set can be determined based on: a trading frequency, the market volatility of the underlying assets (e.g., more different sub-tokens for higher volatility assets, less different sub-tokens for lower-volatility assets), and/or otherwise determined.

Each UAT sub-token within the set is preferably backed by a different mixture of assets (e.g., the UAT asset set), such that the UAT sub-tokens within the set are not substantially identical to each other (e.g., as defined by the wash-sale rule). However, the UAT sub-tokens within the UAT set can be backed by substantially similar asset mixtures, track different primary assets, and/or be otherwise related.

Alternatively, the UATs themselves can be the tradeable assets (e.g., be blockchain tokens), wherein descriptions for UAT tokens herein can be applied to UATs. However, the UAT, UAT sub-token sets, and UAT sub-tokens can be otherwise defined.

In one example, the UAT can track a primary asset, wherein all UAT sub-tokens within the associated UAT set can be backed by different mixtures of assets (e.g., the primary asset mixed with different proportions of one or more secondary assets; mixtures of assets that are different from the primary asset). The mixtures are preferably selected such that all UAT sub-tokens within the UAT set have similar market characteristics to the primary asset, but are not substantially identical to each other or to the primary asset.

The UAT sub-tokens within the UAT set are preferably cryptocurrency tokens or blockchain tokens, but can alternatively be a fund, share, exchange-traded asset, and/or any other suitable asset representation. Different UAT sub-tokens are preferably on the same blockchain (e.g., verifiable by the same blockchain protocol, such as ERC20), but can alternatively be on its own blockchain, a blockchain for the UAT (e.g., wherein the sub-tokens can be distinguished by different auxiliary data or identifiers on the UAT blockchain), and/or on any other suitable blockchain. The UAT sub-token is preferably an ERC20 token, but can additionally or alternatively use any other suitable cryptocurrency protocol (e.g., Bitcoin, Litecoin, Cosmos, Tezos, etc.) or technical standard.

On-chain UAT sub-token actions (e.g., transfer, etc.) can be executed on the blockchain using a transaction signed by a private key of the one or more accounts owning the UAT sub-token, but can be otherwise executed. On-chain UAT sub-token management (e.g., mint, destroy, etc.) can be executed on the blockchain using a transaction signed by the private keys of one or more administrator accounts (e.g., different from or the same as owner accounts). For example, transferring the UAT to a new endpoint (e.g., withdrawal to an off-platform wallet, sending the UAT to a buyer, etc.) preferably requires a transaction identifying the UAT (e.g., using the UAT address) that is signed by the UAT's owner (e.g., by the UAT owner's private key) and broadcast to the respective blockchain network for validation (e.g., by a miner), but the UAT can be otherwise transferred. However, on-chain UAT sub-token actions can be otherwise executed.

The UAT sub-tokens can also be traded on an exchange (e.g., a public market, trading system, decentralized exchange (DEX)), transacted (e.g., purchased and sold), or otherwise used. These actions are preferably performed off-chain (e.g., by an off-chain exchange, on an off-chain ledger), but can alternatively be performed on-chain. In this variant, the UAT sub-tokens can be owned by the platform (e.g., exchange, such as by an administrator on behalf of the owner or other depository institution), wherein the platform logs the beneficial owner (e.g., buyer) of the UAT sub-tokens in a ledger, but can additionally or alternatively be owned by the seller, or by a third party (e.g., wherein the UAT is associated with the respective owner's public address).

A UAT sub-token is preferably backed by an underlying UAT asset set (e.g., including one or more assets), but can be backed by any other suitable collateral. The UAT sub-tokens within a UAT set can be backed by the same set of assets, or by different assets. The UAT can be associated with a UAT asset superset, including all UAT asset sets backing the UAT sub-tokens within the associated UAT set.

The UAT price (and/or the UAT sub-token price) is preferably pegged to the value of the UAT asset set, but can additionally or alternatively be decoupled from the UAT asset set value. In variants, the system can automatically adjust the supply of each UAT (e.g., by minting, selling, buying back, and/or destroying UAT sub-tokens) to adjust the UAT market price to match or track the respective UAT asset set value. However, the UAT value can be otherwise managed.

The assets within the UAT asset sets are preferably exchange-traded assets (e.g., traded on a public exchange, a secondary market, etc.), but can additionally or alternatively be bartered, purchased, sold, or otherwise transacted. The assets preferably have historical pricing data, but can additionally or alternatively not have historical pricing data. The asset (or set of assets) functions as collateral for the UAT, such that the UAT can be redeemed for the UAT's collateral (e.g., equity, bond, commodity, digital representation thereof, etc.) or sale proceeds resulting in sale of the UAT for fiat currency, cryptocurrency, tokens, stablecoins, or other representation of value. The UAT asset set is preferably static once the UAT is minted, but can additionally or alternatively be dynamically adjusted (e.g., by changing the underlying UAT asset set). Examples of assets that can be included within a UAT asset set can include securities, stocks, bonds, ETFs, commodities (e.g., precious metals, oil, etc.), notes, debt obligations, real estate, collectibles, art, derivative contacts, cryptocurrencies (e.g., BTC, ETH, etc.), tokens (e.g., stable coins, tokens representative of the exchange-traded assets, etc.), and/or any other suitable asset.

The composition of assets backing each UAT sub-token (e.g., the UAT asset set) is preferably selected such that the UAT sub-token shares similar market characteristics as the other UAT sub-tokens within the shared UAT set, but is not substantially identical to said other UAT sub-tokens. However, the composition of assets can be otherwise selected.

The assets within the UAT asset sets are preferably correlated (e.g., over a predetermined time period) to each other or to a reference asset (e.g., the primary asset), but can alternatively be uncorrelated. The correlation can be: price movement correlation, event response correlation, geographically related, dividend issuance, buyback correlation, split correlation, causally related, or any other suitable relationship. The asset correlations are preferably determined based on historical data, but can be determined based on industrial sector, risk exposure, causation, and/or otherwise determined.

A UAT asset set can include one or more assets. When the UAT asset set includes multiple assets, each asset can be between 0%-100% of the UAT asset set. The proportion of UAT asset set occupied by a given asset can be calculated by price (e.g., market price), by unit, by risk, by changes thereof (e.g., price change rate), and/or by any other suitable metric. The proportion of an asset within the UAT asset set is preferably fixed, but can alternatively change.

In a first example, a primary asset can form more than 90% of the UAT asset set (e.g., by price), wherein the last 10% can include one or more secondary assets. In a second example, a primary asset can be a largest proportion of the UAT asset set (e.g., above 10%, 20%, 30%, 40%, 50%, 60%, 70%, 80%, 90%, etc.; be more than a sum of the remaining assets, etc.), wherein the remaining proportion of the UAT asset set can be divided equally or unequally between one or more secondary assets. In a third example, a set of assets can have substantially similar proportions (e.g., within 1%, 5%, 10%, etc. difference) within the UAT asset set. In a fourth example, a UAT asset set can include a majority of a first asset (e.g., the largest proportion of the UAT asset set; between 1%-100% of the UAT asset set, etc.) and a minority of one or more secondary assets (e.g., smaller proportions of the UAT asset set than the first asset; individually forming between 0-49% of the asset set; collectively forming between 0-100% of the UAT asset set, etc.); however, the UAT asset set can include equal proportions of different assets, or be otherwise constructed. However, the assets can be included in any other suitable proportion.

The UAT asset set composition (e.g., assets within the UAT asset set, respective weights, etc.) can be: automatically determined (e.g., calculated based on the assets' market characteristics, market price, market ratios, historical correlations with other assets, statutes, etc.), manually selected, and/or otherwise determined. The UAT asset set composition is preferably predetermined, but can alternatively be dynamically determined (e.g., at minting time, at a predetermined frequency, etc.), or otherwise determined.

The UAT asset set can include whole or partial asset units (e.g., $0.90 of a dollar, 70% of a barrel, etc.). When indivisible assets are used in the UAT asset sets, the indivisible assets can be: shared across multiple UAT asset sets, wholly included in a single UAT asset set, converted into a divisible format (e.g., converted into a cryptocurrency token) then subdivided, or otherwise managed.

In a first variant, the UAT asset set can include any quantity of a given asset, as long as the overall proportion of the UAT asset is achieved. This can be particularly useful when indivisible assets are directly used in the UAT asset set, but can include divisible assets as well. For example, to obtain a UAT asset set with 90% AAPL and 10% MSFT, the UAT asset set can include any number of AAPL and MSFT stocks needed to obtain the target proportions.

In a second variant, the UAT asset set can include proportions of a given asset, such that the UAT represents a single unit of an asset. For example, the UAT asset set can include $0.99 USD and $0.01 dollar equivalent of Yen. In a second example, security tokens representing a single unit of indivisible assets (e.g., stocks, bonds, ETFs, etc.) can be minted, wherein a proportion of the resultant security tokens can be included in the UAT asset set. In an illustrative example, an AAPL and MSFT token can be minted for a AAPL share and a MSFT share. 0.9 of the AAPL token and 0.1 of the MSFT can be included in the UAT asset set to obtain a 90%/10% mix; alternatively, x % of the AAPL token and y % of the MSFT token can be included, such that the price breakdown of AAPL:MSFT is the target proportion (e.g., 90% and 10%, respectively).

However, the UAT asset set can be otherwise formed.

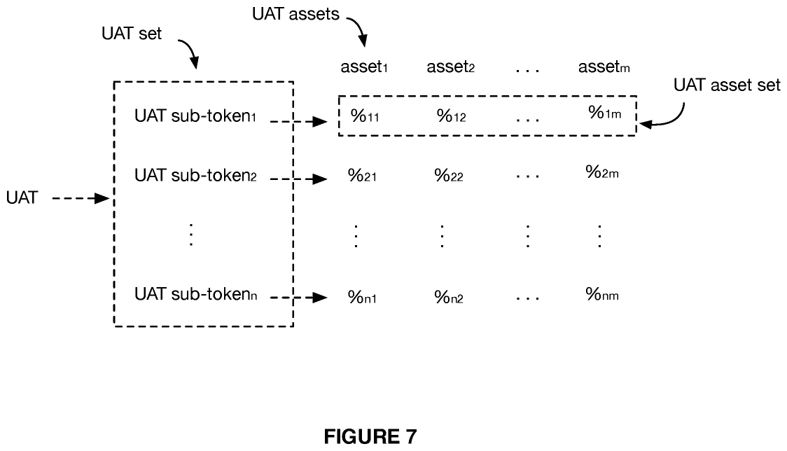

Different UAT asset sets (e.g., for UAT sub-tokens within the same UAT set) can differ in: asset proportion, asset type, asset numerosity, and/or other asset composition parameters. For example, for the UAT asset sets in FIG. 7, %, (e.g., percentage of UAT sub-token₁'s asset set that is asset₁) can be different from %₂₁-%ₙ₁ (e.g., percentages of UAT sub-token₂'s asset set to UAT sub-tokenₙ's asset set that is asset₁, respectively). However, the percentages allocated to a given asset can be the same across one or more UAT asset sets for a UAT set.

In a first example, a UAT is associated with a primary asset. UAT sub-tokens can be created for the UAT that includes the primary asset and one or more secondary assets. The primary asset can be the asset whose price the UAT is intended to track, and the secondary assets can be assets whose price (over time) correlates with the price of the primary asset (e.g., within a predetermined deviation threshold, etc.). In an illustrative example, a UAT sub-token can track AAPL, and can include 90% AAPL and 10% MSFT in the respective UAT asset set. In a second illustrative example, the UAT tracks a single asset (e.g., AAPL only). In a third illustrative example, the UAT sub-token can include 91% AAPL, 7.5% MFST, 1% oil shares, and 0.5% BTC. However, UAT sub-tokens tracking a primary asset can be otherwise constructed.

In a second example, the UAT can be associated with an index or basket, wherein the UAT asset sets underlying all UAT sub-tokens within the same UAT set all have the same market movements, but have vastly different compositions (e.g., differ in asset type, number, proportion, etc.). However, the UAT asset sets can be otherwise constructed.

In some variations, several UAT sub-tokens can be created, each with different UAT asset sets. In some implementations, several sub-tokens are created for a UAT, each sub-token having a set of assets that each include the same primary asset, but include different secondary assets. In some implementations, several sub-tokens are created for a UAT, each sub-token having the same set of assets, but having different weights for the assets.

The UAT (and/or UAT sub-token) is preferably fungible, but can additionally or alternatively be non-fungible. The UAT (and/or UAT sub-token) can be redeemed for a representative amount of the underlying assets. In an example, redeemable UATs can be redeemed in accordance with a process similar to an ETF redemption process. Additionally, or alternatively, some UAT's are not redeemable for the representative amount of the underlying asset. For example, a UAT that represents oil might not be redeemed for a representative amount of oil.

### 4. System.

FIG. 1A shows a system 100. In some variations, the system 100 includes at least one of a Universal Asset Token issuer system 110 and a blockchain trading system 120. The system functions to create and manage Universal Asset Tokens (UATs).

The Universal Asset Token issuer system no functions to mint new UAT sub-tokens. In implementations in which UAT's are minted (as opposed to implementations in which UATs are not actually minted, but instead represented by one or more minted sub-tokens), the issuer system no also functions to mint UATs. The UAT issuer system no can be included in a computing platform (e.g., 102 shown in FIG. 1B). In variants, the platform is a cryptocurrency platform that functions to provide trading for UATs and other tokens or cryptocurrencies. However, the platform 102 can be any suitable type of platform that interacts with one or more blockchain networks (e.g., a blockchain platform, a distributed ledger platform, a decentralized finance (DeFi) platform, etc.). Additionally or alternatively, one or more third-party systems can be used to mint new UATs or UAT sub-tokens. For example, the platform 102 can provide a third party UAT issuer system with a UAT asset set, and the third party UAT issuer system can mint a new UAT or UAT sub-token that includes the assets identified in the provided UAT asset set. In a first variation, the UAT issuer system 110 mints each UAT sub-token supported by the system 100. In a second variation, the system includes a set of one or more UAT issuer systems, each issuer system functioning to mint respective types of UAT sub-tokens. For example, a first UAT issuer system 100 can mint UAT sub-tokens that are backed by stocks and cryptocurrencies, whereas a second UAT issuer system can mint UAT sub-tokens that are backed by commodities (e.g., oil, precious metals, etc.). Each UAT issuer system can be communicatively coupled to a respective asset trading system in that can be used to trade assets in a respective asset marketplace 103.

In variants, each UAT issuer system functions to perform at least one of: minting tokens, destroying tokens, transferring tokens; redeeming tokens (or initiating redemption of tokens); interacting with at least one of an asset trading system 111, a bank transfer module, a digital wallet system, an asset management system 170, and a custody system 112 to perform at least one of purchase of assets, sale of assets, receipt of funds (e.g., fiat, cryptocurrency, token, stablecoin) (e.g., in connection with a purchase of assets), and transfer of funds (e.g., in connection with a sale of assets).

UAT issuer systems (e.g., 110) can be off-chain systems or on-chain systems.

In one variation, the UAT issuer system no includes an on-chain smart contract. The smart contract is preferably executed by the blockchain network (e.g., Ethereum, etc.). In some implementations, the smart contract is a decentralized, anonymous smart contract. However, the smart contract can be any suitable type of smart contract. The system can include a single smart contract that mints all UAT sub-token types, a different smart contract for each UAT sub-token, a different smart contract for each UAT, and/or any other suitable number of smart contracts.

In some variations, the smart contract can perform at least a portion of a process for minting tokens. However, in other variations, any suitable component (or combination of components) of the system can perform at least a portion of the process for minting tokens. In operation, an administrator of the smart contract can: generate a mint transaction calling the minting function of the smart contract, sign the mint transaction, and send the signed mint transaction to the respective blockchain network, wherein the on-chain smart contract can execute the mint function (e.g., wherein the smart contract code associated with the called function is executed by the respective blockchain) and generate a new UAT sub-token. The mint transaction can optionally include: a UAT sub-token identifier (e.g., primary asset identifier, sub-token identifier, etc.), identifiers for the assets backing the sub-token (e.g., serial numbers, hash values, etc.), a recipient's cryptocurrency address (e.g., the issuer system 110, a user's wallet address, etc.), and/or any other auxiliary information, wherein the smart contract can generate the new UAT sub-token based on the auxiliary information.

The smart contract can optionally facilitate token transfer (e.g., sign send requests, route send requests, etc.), initiate redemption of tokens, and/or otherwise manage the tokens. In some implementations, the UAT issuer system 110 includes an off-chain oracle system that functions to monitor events generated by the smart contract, and interact with off-chain systems (e.g., an asset trading system 111, a bank transfer module 132, a wallet system 130, custody system 112) to perform at least one of purchase of assets, sale of assets, receipt of funds, and transfer of funds.

Each UAT issuer system can be communicatively coupled to a respective asset trading system 111 that can be used to trade assets in a respective asset marketplace 103.

In variants, at least one issuer system uses one or more custody systems (e.g., 112) to securely store minted UATs (or UAT sub-tokens). In variants, a custody system (e.g., 112) securely stores UATs (or UAT sub-tokens) held by users (and optionally one or more types of the underlying assets), in association with one or more custody accounts.

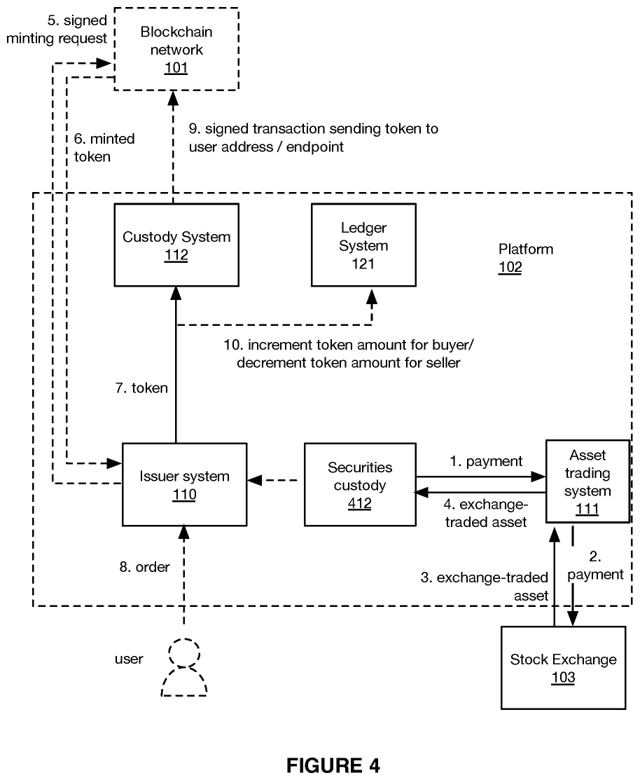

In variants, at least one issuer system uses one or more custody systems (e.g., custody system 112 shown in FIG. 1A, securities custody system 412 shown in FIG. 4) to securely store assets for each minted UAT (or UAT sub-token).

However, any suitable component of the system can use one or more custody systems.

The system 100 can optionally include one or more custody systems (e.g., 112). Custody systems can include multi-asset custody systems and asset-specific custody systems. In some variants, the system includes at least one on-chain custody system. In an example, the system can include one or more custody systems that function to securely store one or more of: cryptocurrency, securities, precious metals, and oil, or any other suitable commodity or asset. In variants, the custody systems are operated by, managed, or used by a respective issuer system 110.

In some implementations, at least one custody system is a physical storage vault that stores physical assets (e.g., gold, paper stock certificates, etc.).

In some implementations, at least one custody system is a cold storage system that functions to securely store tokens, cryptocurrency, or other assets managed by one or more blockchain networks (e.g., 101). In some implementations, digital assets secured by using cold storage are sent to an address with a cold-stored private key. Additionally, or alternatively, custody systems can include one or more of: a central system, a physical system, a distributed system, or any other suitable type of custody system.

In an example, an issuer system that mints UAT sub-tokens that include stocks uses a securities custody system to securely store stocks, whereas an issuer system that mints UAT sub-tokens that include barrels of oil uses an oil custody system (e.g., a secure storage facility) to securely store oil.

The blockchain trading system 120 functions to perform trading of cryptocurrency, tokens, or any other suitable type of assets that are managed by a blockchain network (e.g., 101). In a first variation, the blockchain trading system 120 is UAT-enabled, meaning that it performs one or more processes specific for trading of UATs or UAT sub-tokens (e.g., trading in connection with automatic tax loss harvesting using UATs, trading in connection with an asset management plan that uses UATs, etc.). In a second variation, the blockchain trading system is UAT agnostic, meaning that it performs trading operations for UATs in the same manner as other types of cryptocurrencies, tokens, or blockchain managed assets.

The optional asset management system 170 functions to perform at least one asset management process that uses UATs (e.g., automatic tax loss harvesting, etc.). Additionally, or alternatively, the customer system 160 can perform at least one asset management process that uses UATs.

The optional ledger system 121 functions to record transactions and/or transaction histories for users having user accounts (e.g., managed by a user accounts database). Transactions can include “buy” and “sell” transactions (for cryptocurrencies, UATs, sub-tokens of UATs, etc.) executed by the trading system 120; “deposit” and “withdraw” transactions executed by a wallet system (or custody system 112); and/or other transactions executed by other systems. In some variations, the ledger system 121 functions to record transaction history of user tokens for users (e.g., having user accounts managed by the user accounts database). The ledger system 121 can record: the transaction date, an identifier for the associated token (e.g., the UAT sub-token hash, UAT sub-token type, other UAT sub-token identifier), a token price or value, and/or any other suitable information.

In an illustrative example, the platform 102 can custody the UATs traded on the trading system 120, post and match UAT buy and sell orders (e.g., for the same UAT type), log a sale of the UAT (or portion thereof) with the seller in the ledger 121, and log a purchase of the UAT (or portion thereof) with the buyer in the ledger 121.

One or more components of the system can be included in a cryptocurrency platform (e.g., 102). The cryptocurrency platform can be a single-tenant platform or a multi-tenant platform.

In some variations, one or more of the components of the system are implemented as a hardware device. The hardware device can be any suitable computing device.

In an example, the hardware device includes one or more of a processor (e.g., a CPU (central processing unit), GPU (graphics processing unit), NPU (neural processing unit), microprocessor, etc.), a display device, a memory, a storage device, an audible output device, an input device, an output device, a communication interface, remote computing system, and/or any other suitable computing system. However, the hardware device can include any suitable set of components. In some variations, one or more components included in a hardware device are communicatively coupled via a bus. In some variations, one or more components included in the hardware system are communicatively coupled to an external system via the communication interface.

The communication interface functions to communicate data between the hardware system and another device via a network (e.g., a private network, a public network, the Internet, and the like).

In some variations, the storage device includes the machine-executable instructions for performing at least a portion of the method 200 described herein.

In some variations, at least one component of the system performs at least a portion of the method disclosed herein.

### 5. Method.

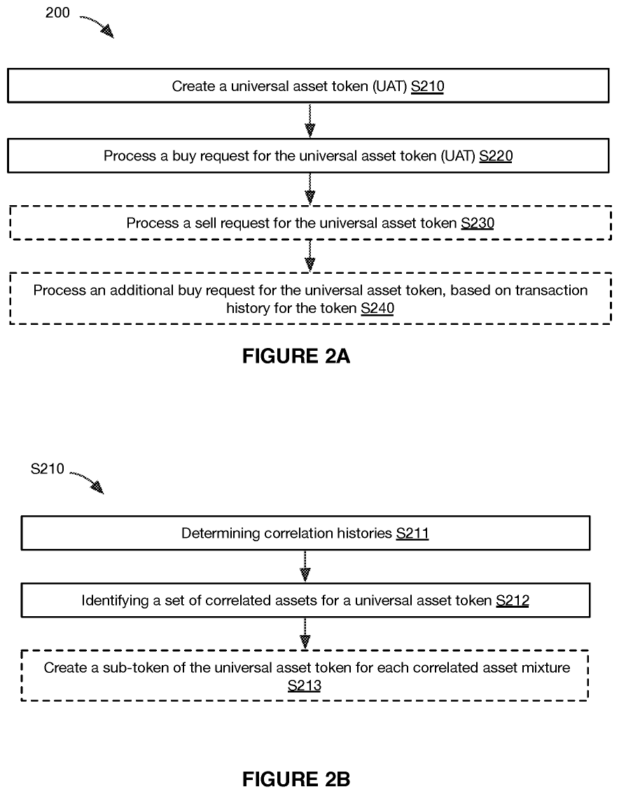

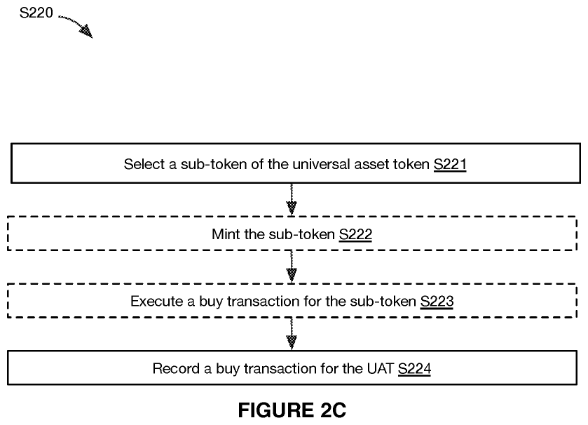

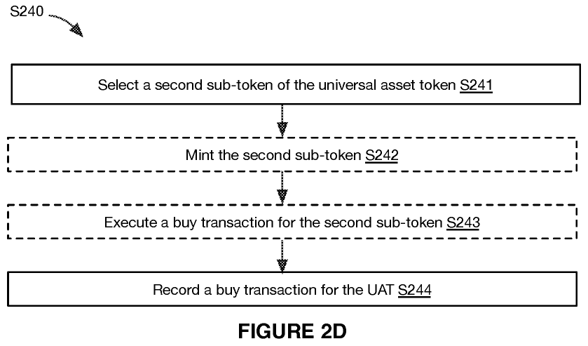

FIGS. 2A-D are flowchart representations of a method 200. The method 200 can be performed by any suitable computing system. In some variations, at least one component of the system 100 performs at least a portion of the method 200.

In some variations, the method 200 includes at least one of: creating a Universal Asset Token (UAT) S210; processing a buy request for a UAT S220; and optionally processing a sell request for a UAT, as shown in FIG. 2A. The method 200 can include processing any combination of buy and sell requests for a UAT. For example, a UAT can be bought (S220), sold (S230), then repurchased (S240). Several buy transactions for the UAT can be processed (each buy request resulting in execution of a buy transaction for purchasing of a UAT sub-token associated with the UAT), at different times (e.g., at S220 and thereafter at S240), and then a portion (or all) of the UAT can be sold (e.g., at S230), and possibly repurchased at a later time. Buy and sell requests can be processed to implement tax loss harvesting.

In an example, the method 200 can include: determining a set of UAT sub-tokens (UAT set) associated with a UAT; processing a buy request for the UAT by transferring a UAT sub-token of the set to a user account; and optionally processing a sell request for the UAT by transferring the UAT sub-token out of the user account. The method can optionally include purchasing a second UAT sub-token from the UAT set in conjunction with first UAT sub-token sale and transferring the second UAT sub-token to the user account (e.g., automatically), wherein the second UAT sub-token is not substantially identical to, but has similar market characteristics with, the first UAT sub-token.

Creating a UAT S210 functions to create one unit (e.g., token) of the UAT sub-token. Alternatively, creating the UAT S210 can include creating all or a portion of the UAT sub-tokens within the UAT set. The UAT sub-token can be cryptographically minted by a smart contract (e.g., a minter), by a system (e.g., issuer system 110), mined, or otherwise created. Each UAT sub-token is preferably minted by a minter (e.g., issuer system 110) specific to the UAT sub-token, but can additionally or alternatively be minted by a generic minter or by any other suitable minter. The UAT sub-tokens are preferably minted offline, but can additionally or alternatively be minted online.

UATs can be created (at S210) any suitable time, and in response to any suitable trigger. UAT creation triggers can include occurrence of a minting event initiated by an issuer system 111, trading system 120, asset management system 170, customer system 160, and the like. Examples of minting events include: receipt of a UAT purchase request from a user (e.g., via customer system 160), determination that the UAT supply (and/or UAT sub-token supply) is too low, determination that an asset within the UAT asset set has reorganized (e.g., issued dividends, split, reverse split, etc.), a tax loss harvesting operation (e.g., performed by an asset management system 170, etc.), or other minting events. UATs can be created in a batch, or otherwise created. In a first variation, an individual UAT sub-token is minted for each S210 instance. In a second variation, all UAT sub-tokens within the UAT set are minted for each S210 instance. However, any number of UAT sub-tokens can be minted at any other suitable time.

The created UATs' owner can be: the issuer system (e.g., 110), a user purchasing the new UAT (e.g., wherein the user address can be passed to the smart contract during minting), or be any other suitable entity (e.g., any other suitable address).

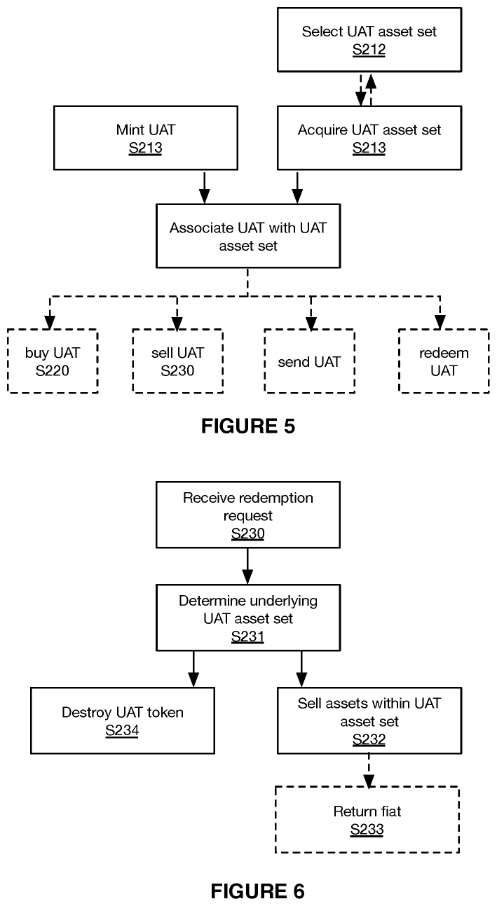

Creating a UAT S210 can additionally include obtaining the assets within the UAT asset set(s) (example shown in FIG. 5). One UAT is preferably minted for each unit of the asset or asset set received (e.g., as collateral) by the UAT issuer system 110, but any suitable number of UATs (and/or UAT sub-tokens) can be minted per asset unit. The assets within the UAT asset set can be purchased when the UAT is minted, before UAT minting, or after UAT minting. For example, when an amount of a UAT is minted (e.g., by a UAT issuer system 110, by a smart contract, etc.), an amount of the UAT's asset (or set of assets) is preferably purchased (e.g., an amount that corresponds to an amount of the minted UAT). In a specific example, for a UAT representing ownership of one share of Apple stock (AAPL), for each AAPL UAT minted, the issuer system 110 can control the asset trading system 111 to purchase one share of AAPL stock on behalf of a custody account of the custody system 112. The issuer system 110 can purchase the collateral asset (e.g., AAPL stock) by using fiat currency received from a user (e.g., by using a bank transfer module) (and held, e.g., in a bank account of the issuer system 110, the custody system 112, etc.) or using a token, cryptocurrency, or stablecoin of the user (e.g., managed by a digital wallet, the custody system 112, etc.), or using any other suitable collateral. The issuer system 110 can purchase the asset by using the asset trading system 111 (e.g., an electronic stock trading system, a broker-assisted trading system, etc.). The UAT can be associated with the serial numbers of the underlying assets (e.g., stock certificate number), wherein the asset's serial numbers can be passed to the minter during UAT minting or be assigned to the UAT after the fact (e.g., in a backend, off-chain ledger), but can be otherwise associated with specific assets or unassociated with specific assets.

Creating a UAT can include determining UAT sub-tokens that share similar characteristics (e.g., price movement, risk exposure, etc.). These UAT sub-tokens can be used, for example, to implement tax loss harvesting.

Examples of shared characteristics can include: a common primary asset (e.g., wherein the respective UAT asset sets includes 50% or more of the same primary asset type, such as AAPL), correlated market movements (e.g., wherein the respective UAT asset sets include assets that have similar market movements, such as AAPL and MSFT), common tracked reference (e.g., region, market, sector, etc.), or any other suitable characteristic.

Determining UAT sub-tokens that share similar characteristics can include one or more of: determining correlation histories S211; identifying a set of correlated assets for the UAT S212; and creating (e.g., minting) a UAT sub-token for the UAT for each set of correlated assets S213, as shown in FIG. 2B.

In some variations, an issuer system 110 generates correlation histories (S211). However, other components of the system 100 can perform all or a portion of S211.

Determining correlation histories (S211 shown in FIG. 2B) can include: defining at least one UAT asset set that includes a primary asset for the UAT. For each UAT asset set, the primary asset is the asset whose price is primarily used to determine the price of the UAT. For example, a user wishing to buy a UAT that represents ownership in Apple stock can purchase a UAT sub-token of the AAPL UAT that has AAPL stock as the primary asset.

In a first example, a first UAT asset set is defined that includes only the primary asset of the UAT. In a second example, each UAT asset set includes the primary asset of the UAT, and one or more secondary assets.

In variants, the system 100 selects each secondary asset for a UAT asset set according to a set of rules (e.g., based on the respective assets' historical price correlation, based on a market index, a sector index, a regional index, etc.). However, in some variations, the secondary assets are selected randomly, or otherwise selected. In some implementations, assets within the UAT asset set can represent an asset class (e.g., different stock types or classes, different bond types, different regions, different sectors, etc.). In some implementations, at least one asset within the UAT asset set represents an index (e.g., S&P500, NYSE, Coinbase Exchange, Binance, etc.). However, the assets within the UAT asset set can be otherwise selected.

In a first variant, a UAT asset set includes one or more assets. For example, a UAT asset set can include a first amount of shares of Google stock, and a second amount of shares of Apple stock. In a second variant, a UAT asset set includes one or more tokens that represent individual assets. For example, a UAT asset set can include a first amount of a token that represents a share of Google stock, and a second amount of a token that represents a share of Apple stock. In a third variant, a UAT asset set includes at least one token that represents a customized ETF. The customized ETF can represent one or more assets, and a customized ETF can be created for one or more UATs or UAT sub-tokens.

Each asset included in the UAT asset set can be weighted. The weights are preferably percentages of the total UAT asset set's value (e.g., 90% value from primary asset, 10% value from secondary asset, etc.), but can additionally or alternatively be the unit composition of the UAT asset set (e.g., 90% of the UAT assets are primary assets, 10% of the UAT assets are secondary assets), percentages of each constituent asset (e.g., 90% of a primary asset, 10% of a secondary asset), or otherwise determined. Whole or partial assets can be included in the UAT asset set. For example, a UAT asset set can include a first percentage (e.g., 90%) of a single share of the primary asset and a second percentage (e.g., 10%) of a single share of the secondary asset. In this example, the residual percentages of the primary and secondary assets can be assigned to UAT asset sets for other UATs, or otherwise used.

The respective weights for each asset can be selected according to: a set of rules, randomly selected, evenly divided, or otherwise selected. In a first example, the weights are chosen for the assets of the a UAT asset set such that a UAT sub-token created using the asset set is not “substantially identical” to the primary asset (as defined by applicable tax law). In a second example, the weights are selected such that the value of the resultant UAT asset set tracks a primary asset's market movements (e.g., are heavily weighted toward the primary asset). However, the weights can be otherwise selected. However, the UAT can represent any other suitable set of assets.

In variants, selecting weights for the assets in a UAT asset set includes selecting the maximum weight value for the primary asset that satisfies applicable tax law related to tax loss harvesting.

In variants, the weights for the assets of the UAT asset sets can be updated in response to any suitable trigger. For example, in a case of a change in tax law, weights for the assets of the UAT asset sets can be updated to comply with tax law changes, such that UAT sub-tokens using these UAT asset sets can be used to implement tax loss harvesting.

In a first example of weighting assets in a UAT asset set, the primary asset value is at most 99.9% of the total value of the UAT asset set. In a second example, the primary asset value is at most 99% of the total value of the UAT asset set. In a third example, the primary asset value is at most 95% of the total value of the UAT asset set. In a fourth example, the primary asset value is at most 90% of the total value of the UAT asset set. However, the assets in a UAT asset set can have any suitable weights.

For each defined UAT asset set, historic values of the primary asset and each secondary asset over a time period are accessed. In variants, each secondary asset included in a UAT asset set is selected from a set of assets that can be used as collateral for the UAT. In variants, the assets that can be used as collateral for the UAT is preferably determined by the issuer system being used to create the UAT sub-token.

In some implementations, the values of the primary and secondary assets are determined with reference to a fiat currency (e.g., U.S. dollars). In some variations, each asset set includes a single type of asset (e.g., stock, commodity, etc.). In some variations, one or more asset sets includes a mixture of asset types (e.g., stock, commodity, cryptocurrency, etc.).

Identifying a plurality of sets of correlated assets for the UAT (S212) can include selecting one or more of the asset sets defined at S211, by using the historic values accessed at S211. In some variations, each UAT asset set selected at S212 includes the primary asset and one or more secondary assets whose changes in combined value over the time period correlate with changes in the value of the primary asset over the time period (as indicated by the historic values accessed at S211). In variation, a correlation metric is computed for each UAT asset set. Each correlation metric quantifies a correlation of changes in combined value of the secondary assets over the time period with changes in the value of the primary asset over the time period. The correlation metrics are used to select the UAT asset sets. For example, if a UAT asset set has a correlation metric that satisfies a correlation constraint (e.g., exceeds a threshold value), then the UAT asset set is selected.

In variants, a plurality of UAT asset sets are selected at S212. In a first example, a predetermined number of UAT asset sets are selected. In a second example, each UAT asset set that has a correlation metric that satisfies the correlation constraint is selected.

In variants, a plurality of UAT asset sets are selected at S212, and the selected UAT asset sets are ranked according to the respective correlation metrics.

For example, a UAT asset set that includes the primary asset and a secondary asset whose price (over time) is most highly correlated with the price of the primary asset would be the highest ranked asset set (“A set), an asset set that includes the primary asset and a secondary asset whose price (over time) is the second-most highly correlated with the price of the primary asset would be the second highest ranked asset set (“B set), an asset set that includes the primary asset and a secondary asset whose price (over time) is third-most highly correlated with the price of the primary asset would be the third highest ranked asset set (“C set), and so forth.

In some variations, each selected UAT asset set has a same number of secondary assets. Alternatively, one or more of the selected UAT asset sets can have a different number of secondary assets.

In variants, after selecting one or UAT asset sets at S212, additional UAT assets are defined and evaluated based on the asset sets selected at S212. In some implementations, secondary assets of one or more of the selected UAT asset sets are combined to form a new UAT asset set that includes the primary asset. In an example, a first group of UAT assets are selected at S212, each having a single secondary asset, the selected UAT asset sets are ranked according to the respective correlation metrics, and the secondary assets of the two highest ranked UAT asset sets are combined to create a new UAT asset set that includes the two secondary assets whose value is most correlated with the primary asset. This process can be repeated to generate further UAT asset sets. In this manner, UAT asset sets having any number of secondary assets can be generated, to identify UAT asset sets are most likely to track future valuation changes of the primary asset.

At S213, a UAT sub-token is created for at least one UAT asset set selected at S212. In some variations, creating a UAT sub-token at S213 includes generating a UAT smart contract for each UAT asset set selected at S212. In some implementations, each UAT smart contract implements functionality for transferring ownership of the respective sub-tokens. In some implementations, each UAT smart-contract (for a UAT asset set) generates events that are monitored by an oracle system, which provides interaction between the UAT smart contract and one or more off-chain systems (e.g., an asset trading system 111, a bank transfer module, a digital wallet system, a custody system 112, etc.). In some variations, the UAT smart contracts are on-chain systems (e.g., smart contracts whose code is stored on a blockchain and executed in accordance with a blockchain protocol). In some variations, at least one UAT sub-token is created using one or more off-chain systems.

In some variations, each UAT smart contract manages a UAT sub-token whose value is computed based on values of the assets included in the UAT asset set associated with the UAT smart contract. In some variations, the values of the primary asset and each secondary asset are weighted, and the weighted values are used to determine the value of the UAT sub-token. In some implementations, each UAT smart contract implements a value( ) method that determines a value of the UAT sub-token (e.g., in fiat currency, in cryptocurrency, such as BTC, stablecoin, etc.). In one example, a percentage is assigned to each asset of a UAT sub-token, and the value of the UAT sub-token is computed by determining the mathematical product of the price of each asset of the UAT sub-token and its assigned percentage, and summing the determined products to identify the value, as shown below:

Sub_token_value=(x₁%*Primary_asset_value)+(x₂%*Secondary_asset_value)

In some variations, the UAT sub-token is backed by a majority share of the primary asset and a minority share of the secondary asset (or combination of second assets). In some variations, the percentage assigned to the primary asset is greater than 50%. In some variations, the percentage assigned to the primary asset is the maximum percentage allowed to comply with regulations regarding tax loss harvesting.

In variants, at least a portion of S213 is performed before receiving a buy request. In an example, a UAT smart contract for each UAT asset set selected at S212 is generated before receiving a buy request, and a pre-generated UAT smart contact can be used to mint a UAT sub-token during processing of a buy request at S220.

In variants, the blockchain trading system 120 processes a buy request for a UAT (at S220). Alternatively, another component of the system can be used (either with or without the trading system 120) to process a buy request at S220. In some variations, processing a buy request (S220) includes receiving purchasing funds from a user associated with the buy request (e.g., via a bank transfer module, the digital wallet system, a custody system 112, etc.).

The buy request is preferably performed in response to a trigger, which can be an event or request generated by one or more components of the system 100. In a first example, the blockchain trading system 120 processes a buy request in response to a buy request received from a customer system 160. The buy request received from the customer system 160 can be a request to buy a UAT on behalf of a user associated with a user account managed by the platform 102. In a second example, the blockchain trading system 120 processes a buy request in response to a buy request received from the asset management system 170. In a third example, the S220 is performed in response to sale of a related UAT sub-token (e.g., a UAT sub-token within the same UAT set). However, S220 can be performed at any other suitable time. The buy request received from the asset management system can be a request to buy a UAT in connection with an asset management operation (e.g., a portfolio rebalancing operation, a tax loss harvesting operation, etc.).

In some variations, the buy request specifies a purchase amount (e.g., in fiat, stable coin, such as USDC, etc.) to purchase the UAT. In some variations, the buy request is associated with (or identifies) a user account (e.g., managed by the platform 102). The buy request can be received via an API (e.g., a REST API), remote procedure call, user interface (e.g., a graphical user interface provided by a web application, a user interface provided by a native client application), or any suitable type of interface. In variants, the API operates in accordance with a communication protocol. In some implementations, the API operates in accordance with the Financial Information eXchange (FIX) protocol. However, the API can operate or implement any suitable communication protocol.

S220 can include selecting a UAT sub-token (e.g., within the UAT set associated with the UAT) for purchase S221. The UAT sub-token can be selected: according to rules, heuristics, manually (e.g., specified by the buy request), randomly, or otherwise determined. Examples of rules include: selecting UAT sub-tokens (e.g., associated with the UAT and/or from the UAT set associated with the UAT) that have not been purchased by the user account within a predetermined prior timeframe (e.g., 30 days); selecting UAT sub-tokens (e.g., from the UAT set) that have not been sold within a predetermined prior timeframe (e.g., 30 days); selecting the same UAT sub-tokens already held by the user account; and/or any other suitable rules.

In a first example, the buy request specifies a specific UAT sub-token. In a second example, rather than specifying a specific sub-token of the UAT, the buy request specifies a UAT, and processing the buy request includes selecting either the primary asset of the UAT, or a UAT sub-token of the associated UAT set (S221 shown in FIG. 2C).

S221 can be performed by the trading system, the system component that provides the buy request performs the selection at S221, and/or by any other suitable system.

The selection is preferably performed at S221 based on the user's transaction history for the UAT (and/or related UAT sub-tokens). In some implementations, the user's transaction history for the UAT is recorded in a ledger system of the platform 102 (e.g., 121 shown in FIG. 1B). In a first variant, if the user has no transaction history for the UAT (or UAT primary asset), the user has not purchased the UAT (or UAT primary asset), or the user's last sale of the UAT (or UAT primary asset) was before a predetermined date (e.g., 30 days before the current date, or any other suitable date that satisfies applicable laws), then the system 100 (e.g., the platform 102, the trading system 120, the asset management system 170, the customer system 160, etc.) selects any UAT sub-token associated with the UAT. In a second variant, even if the user has never purchased the UAT (or UAT primary asset), the system 100 selects a UAT sub-token of the UAT (based on the user's transaction history for the UAT). In some implementations, the system 100 selects a UAT sub-token associated with the UAT (e.g., with the highest correlation metric, randomly selected, etc.) and that has either a) never been purchased by the user, or b) was last sold by the user before a predetermined date (e.g., 30 days before the current date, or any other suitable date that satisfies applicable laws). However, any other suitable UAT sub-token can be selected. By virtue of always purchasing a UAT sub-token, rather than the primary asset tracked by the UAT, tax loss harvesting operations (e.g., performed by the asset management system 170 using UATs) can be successfully performed even if the associated user holds the primary asset in an account that is not known to the platform 102.

In variants, the sub-token selected at S221 is not “substantially identical” to any previously sold sub-token of the same UAT (e.g., within a predetermined time period), as defined by applicable tax law.

In an example, for a user's first “AAPL UAT” buy request, the system 100 selects the most correlated sub-token (A-set sub-token), records the user's “buy” of AAPL UAT (e.g., in the ledger system 121 shown in FIG. 1B), and in a case where the user sells the A-set sub-token and issues a request to buy-back “AAPL UAT”, the system 100 selects the second-most correlated sub-token (B-set sub-token).

In a first variation, after selecting the UAT sub-token at S221, a previously minted amount of the UAT sub-token is purchased (e.g., on an exchange, from a user, etc.). In some implementations, an amount of the sub-token is pre-minted and custodied by the custody system 112 before processing of a buy request, such that minting does not need to be performed during processing of a buy request.

In a second variation, after selecting the UAT sub-token at S221, an amount of the UAT sub-token is minted at S222, so that the minted UAT sub-token can be purchased. In some implementations, selecting a UAT sub-token at S221 includes selecting one of the UAT asset sets selected at S212 (during creation of the UAT). In a first example, minting the UAT sub-token at S222 includes selecting the UAT smart contact that is pre-generated (at S213) for the selected UAT sub-token, and controlling the selected UAT smart contract to mint the amount of the UAT sub-token. In a second example, minting the UAT sub-token at S222 includes accessing information that specifies the UAT asset set for the selected UAT sub-token, and providing information identifying the UAT asset set to a generic UAT minting smart contract to mint the amount of the UAT sub-token. The generic UAT minting smart contract mints a sub-token that represents the assets identified by the provided UAT asset set.

The system 100 preferably controls the UAT smart contract (used for the minting) to mint the amount of the UAT sub-token in response to purchase (or receipt) of corresponding amounts of the primary asset and any secondary assets of the UAT sub-token. However, the UAT smart contract can perform the minting before purchase of the assets used as collateral for the UAT sub-token. In a first implementation, the smart contract controls purchase of the underlying assets of the UAT sub-token (e.g., by using an asset trading system 111). In a second implementation, an off-chain issuer system controls purchase of the underlying assets of the UAT sub-token (e.g., by using an asset trading system 111). In a third implementation, a custody system (e.g., 112) controls purchase of the underlying assets of the UAT sub-token (e.g., by using an asset trading system 111). In some variations, funds (e.g., fiat, stablecoin, cryptocurrency, etc.) used for the purchase of the assets are received from the user (associated with the buy request) by the platform 102 from one of the digital wallet system, a custody system 112, and a bank transfer module. However, the UAT sub-token can be otherwise minted.

In some variations, the amount of the sub-token that is to be minted is determined based on a purchase amount (e.g., in fiat currency, stablecoin, cryptocurrency, etc.) identified by the buy request. For example, for a $100, buy request for the UAT, amounts of each asset of the sub-token are purchased (or acquired) such that the total market value (at the time of the buy request) equals $100, and the amounts of the assets are acquired in accordance with the asset weights defined for the sub-token. Once the assets have been purchased (or acquired) the sub-token is minted, such that the acquired assets function as collateral for the minted amount of the sub-token.

In some variations, the trading system 120 executes a buy transaction for the UAT sub-token (S223). This can be performed after minting the amount of the sub-token (at S222), in response to purchase order/sale order match within an exchange, or at any other suitable time. In some variations, S223 includes confirming that the user associated the buy transaction has transferred funds (or has a sufficient balance of funds available at the platform 102) for the buy request, and responsive to a confirmation that the user has transferred funds (or has a sufficient balance), the trading system 120 decrements the amount of the UAT (identified within the order) from the seller and increments the amount of the UAT for the buyer in a ledger (e.g., 121).

Alternatively, the trading system 120 can trigger an off-platform send of the UAT amount (e.g., from the system 100, from the seller) to a user account of the user in response to buy transaction confirmation, receipt of a withdrawal request, or in response to any other suitable send event. In some variations, the trading system 120 uses a smart contract to transfer the amount of the UAT sub-token to a blockchain address associated with the user account. In some variations, the amount of the sub-token is an amount that corresponds to a purchase amount (e.g., in fiat, stablecoin, cryptocurrency) associated with the buy request. In some variations, the amount of the sub-token is the amount minted at S222. In some variations, the amount of the sub-token is greater than an amount minted at S222. In some variations, the amount of the sub-token is less than an amount minted at S222.

In some variations, after executing the buy transaction, the trading system 120 records a buy transaction for the UAT (S224). In some implementations, the ledger system 121 records the buy transaction in association with an identifier for the user of the buy transaction. The recorded transaction is added to the trading history of the user for the UAT. In some implementations, the recorded buy transaction for the UAT identifies at least one of: the UAT sub-token (selected at S221), the amount of the sub-token transferred to the user (at S223), the user account, a time of the buy transaction, and the UAT (e.g., “buy AAPL UAT; A-Set sub-token; <amount 1>; for User A; date MM-DD-YYYY; time HH:MM”).

Processing a sell request (S230) on behalf of the user for the UAT (purchased at S220) functions to realize gains or losses resulting from UAT market movements. S230 can be performed: in response to receipt of a sell request, automatically (e.g., in response to an automatic sell event), at a predetermined time, and/or at any other suitable time. Examples of automatic sell events include: a price (e.g., a primary asset price, UAT price, UAT sub-token price, etc.) increase more than a threshold amount since purchase, drop more than a threshold amount since purchase, and/or any other suitable event. The threshold amounts can be: set by the user, automatically determined by the system, predetermined, or otherwise determined.

S230 can optionally include selecting the UAT sub-token to sell S231 (e.g., when the user account is associated with multiple related UAT sub-tokens or UAT sub-tokens associated with the same UAT or UAT set). The selected UAT sub-token can be selected: according to a set of rules, heuristics, randomly, manually selected, or otherwise selected. Rules can include: selecting the oldest UAT sub-token (e.g., from the UAT set identified by the UAT), selecting a UAT sub-token that has been held for more than a predetermined period of time (e.g., 1 year, a short-sale period), and/or selecting any other suitable sub-token.

In a first variation, processing a sell request includes matching the sell request with a buy request (e.g., purchase order), and adjusting the buyer's and seller's UAT balances, respectively. In a second variation, processing a sell request includes selecting a UAT sub-token of the UAT (e.g., a sub-token owned by the user that is least correlated with a primary asset used as collateral for the UAT) (S231), and selling the selected sub-token (e.g., broadcasting a signed transaction sending the UAT to the buyer's address to the blockchain network). For example, if the user holds $100 of an A-set sub-token of the UAT and $100 of a B-set sub-token of the UAT, during processing of a sell request to sell $100 of the UAT, the B-set sub-token is selected for the sell request. In some implementations, the issuer system 110 performs selection of the sub-token to be sold. In some implementations, the trading system 120 performs selection of the sub-token to be sold. However, any component of the system 100 can perform selection of the sub-token to be sold.

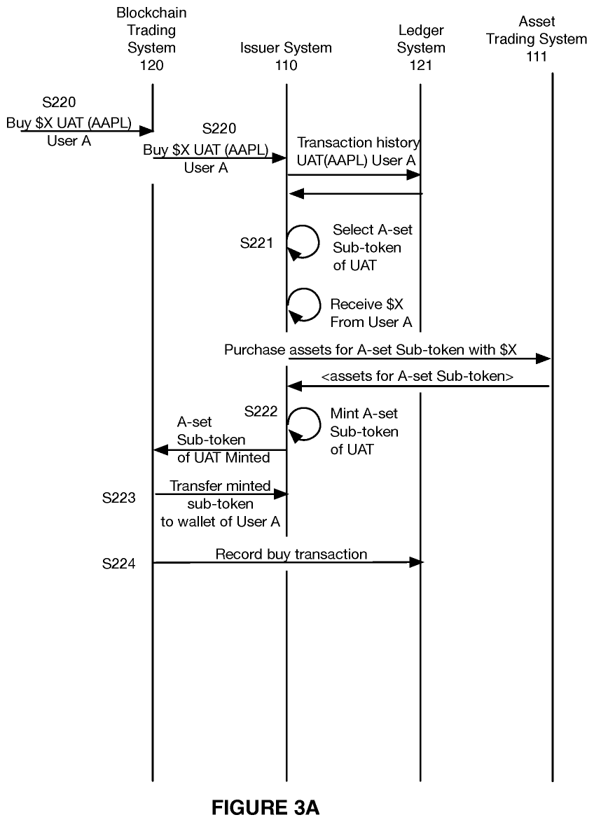

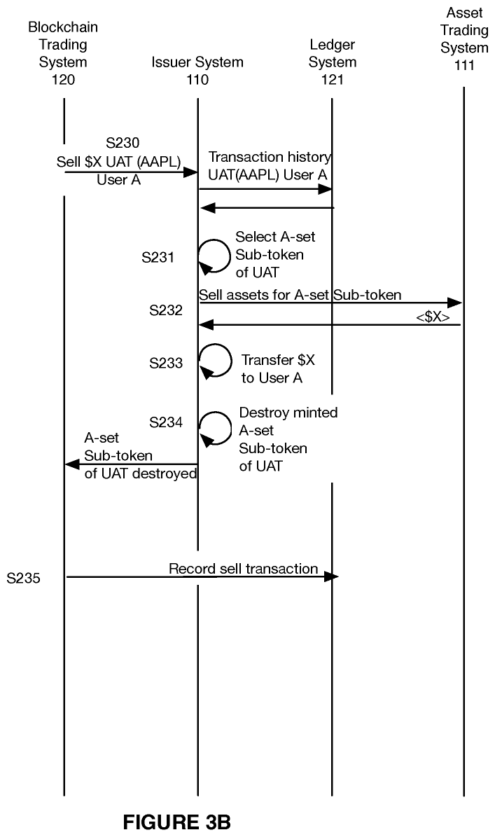

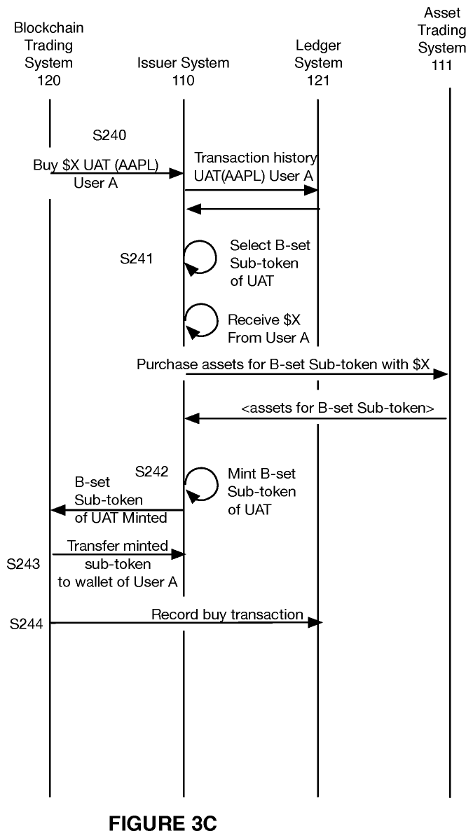

In an example, for a sell request to sell an amount (e.g., 100) of the UAT, the UAT sub-token is selected (S231 shown in FIG. 3B), and an amount of the assets used as collateral for UAT the sub-token (e.g., 100) is sold (e.g., by using the asset trading system iii) (S232), and the proceeds from the sale of the assets are returned to the user (associated with the sell request) (S233) via at least one of a bank transfer module and a digital wallet system.

In some variations, after executing the sell transaction, the trading system 120 records a sell transaction (e.g., “sell AAPL UAT; A-Set sub-token; <amount 1>; for User A; date MM-DD-YYYY; time HH:MM”) for the UAT on behalf of the user at the ledger system 121, as trading history of the user account for the UAT (S235). In some implementations, the recorded sell transaction for the UAT identifies at least one of the sub-token (selected at S230), the amount of the sub-token sold by the user (at S230), the user account, a time of the sell transaction, and the UAT.

In some variations, processing of additional buy requests for the UAT on behalf of the user is performed based on the transaction history of the UAT recorded for the user (S240).

In variants, with an asset management system (e.g., 170), automatically provides the sell request (at S230) and the second buy request at S240 to the blockchain trading system during processing of a tax loss harvesting operation. In variants, the asset management system provides the second buy request to the blockchain trading system at S240 in response to completion of the sell request at S230. In this manner, the associated user maintains exposure to the primary asset associated with the requests, and benefits from tax loss harvesting.

S240 can include one or more of: selecting a second sub-token of the UAT S241; optionally minting the sub-token (e.g., if the system does not currently manage an amount of the sub-token sufficient to fulfill the request) S242; executing a buy transaction for the sub-token S243; and recording a buy transaction for the UAT S244.

In some variations, if the sub-token purchased at S220 has not been sold (or has not been sold within a predetermined period, e.g., the last 30 days), then the same sub-token selected at S221 is selected at S241. However, if the sub-token purchased at S220 has been sold (or has been sold within a predetermined period, e.g., the last 30 days) as indicated by transaction history of the user for the token (e.g., recorded at S235), then a different sub-token is selected at S241. By virtue of selecting a different sub-token at S241 if the sub-token purchased at S220 has been sold (or has been sold within a predetermined period, e.g., the last 30 days), tax loss harvesting can be performed at arbitrary intervals.

FIGS. 3A-C show exemplary execution of buy and sell transactions for UATs.

As shown in FIG. 3A, the trading system 120 receives a request (e.g., from a client system 160) to buy an amount of a UAT (e.g., that corresponds to AAPL stock), on behalf of User A, and for a purchase amount ($X) in fiat currency (e.g., USD) (S220). The trading system 120 requests the issuer system 110 to mint an amount of the UAT that corresponds to the purchase amount (S220). The issuer system 110 queries the ledger system 121 for transaction history of the User A for the UAT for AAPL, and determines that User A has not previously sold the A-set sub-token for the UAT (or has not sold the A-set sub-token within a restricted period). The issuer system 110 selects the A-set sub-token (S221). The issuer system 110 receives the fiat currency from an account of User A (e.g., via one of a digital wallet system, a custody system 112, and a bank transfer module). The issuer system 110 uses the received fiat currency to purchase the assets for the A-set sub-token by using the asset trading system 111.

The issuer system 110 then mints the A-set sub-token and sends the trading system 120 a notification that the A-set sub-token has been minted (S222).

The trading system 120 then transfers the minted sub-token to a digital wallet of User A (S223), and records the buy transaction at the ledger system 121 (S224). The buy transaction identifies the AAPL UAT, the A-set sub-token (of the AAPL UAT), the User A, the purchase amount, and the time of the purchase.

Although the issuer system 100 is shown as performing S221 in FIG. 3A, any suitable component of the system 100 (e.g., the trading system 120) can perform at least a portion of S221.

As shown in FIG. 3C, the blockchain trading system 120 processes a second request to buy an amount of a UAT (e.g., that corresponds to AAPL stock), on behalf of User A, and for a purchase amount ($X) in fiat currency (e.g., USD) (S240). In some implementations, the blockchain trading system 120 processes the buy request in connection with an automatic tax loss harvesting process (e.g., performed by the asset management system 170). In an example, the tax loss harvesting process includes automatically performing a buy request to buyback the UAT sold in connection with a tax loss harvesting sale (e.g., performed by the asset management system 170).

The trading system 120 requests the issuer system 110 to mint an amount of the UAT that corresponds to the purchase amount of the second buy request. The issuer system 110 queries the ledger system 121 for transaction history of the User A for the UAT for AAPL, and determines that User A has previously sold the A-set sub-token for the UAT within the restricted period (e.g., within the last 30 days). The issuer system 110 selects the B-set sub-token (S241). The issuer system 110 receives the fiat currency from an account of User A via one of a digital wallet system, the custody system 112, and a bank transfer module. The issuer system 110 uses the received fiat currency to purchase the assets for the B-set sub-token by using the asset trading system 111.

The issuer system 110 then mints the B-set sub-token and sends the trading system 120 a notification that the B-set sub-token has been minted (S242).

The trading system 120 then transfers the minted sub-token to a digital wallet of User A (S243) and records the buy transaction at the ledger system 121 (S244). The buy transaction identifies the AAPL UAT, the B-set sub-token (of the AAPL UAT), the User A, the purchase amount, and the time of the purchase.

Although the issuer system 100 is shown as performing S241 in FIG. 3C, any suitable component of the system 100 (e.g., the trading system 120) can perform at least a portion of S221.

In some variations, S230 includes the trading system 120 executing a redemption transaction for the sub-token selected at S230. The redemption transaction can be for an amount corresponding to a redemption request, for a market amount, or for any other suitable amount. The UAT can be redeemed (e.g., exchanged for the underlying UAT asset set or exchanged for fiat) in response to: receipt of a redemption request (e.g., from the issuer system, generated in response to occurrence of a redemption event such as UAT deprecation; example shown in FIG. 6), receipt of a sell request, or at any other suitable time. In some variations, S230 includes the trading system 120 controlling the issuer system to sell the assets used as collateral for the sub-token (e.g., by using the asset trading system in) (S232) and transferring the sale proceeds to a recipient (e.g., the issuer system, the user, etc.) via at least one of a bank transfer module and a digital wallet system (S233). In some variations, in response to the sale of the assets, the issuer system removes from circulation, the amount of the sub-token corresponding to the sell request, such that it is not associated with any user accounts and cannot be transferred to any user accounts (S234). Examples of UAT removal from circulation include: sending the UAT amount to a burner address and optionally destroying the private key associated with the burner address (e.g., burning the token), or otherwise removing the UAT from circulation.

As shown in FIG. 3B, the blockchain trading system 120 processes a request to sell an amount of a UAT (e.g., that corresponds to AAPL stock), on behalf of User A, and for a sale amount ($X) in fiat currency (e.g., USD) (S230). In some implementations, the blockchain trading system 120 processes the sell request in connection with an automatic tax loss harvesting process (e.g., performed by the asset management system 170). In some implementations, the blockchain trading system 120 processes the sell request in response to a request received from a customer system 160.

The trading system 120 requests the issuer system 110 to sell an amount of the UAT that corresponds to the sale amount. The issuer system 110 queries the ledger system 121 for transaction history of the User A for the UAT for AAPL, and determines that User A only has the A-set sub-token for the UAT. The issuer system 110 selects the A-set sub-token (S231). The issuer system 110 then sells the assets for the A-set sub-token by using the asset trading system 111 (S232), and transfers the sale proceeds to the User A via one of a digital wallet system, a custody system 112, and a bank transfer module (S233).

The issuer system 110 then destroys the A-set sub-token and sends the trading system 120 a notification that the A-set sub-token has been destroyed (S234).

The trading system 120 then records the sell transaction at the ledger system 121 (S235). The sell transaction identifies the AAPL UAT, the A-set sub-token (of the AAPL UAT), the User A, the sale amount, and the time of the sale.

In variants, the method includes providing owners of UATs with rewards (e.g., dividends, interest, crypto rewards, and the like) associated with the underlying assets of the UAT. In an example, the assets for each UAT are securely managed by at least one custody system, and the rewards for custodied assets are received by the owner of the custodied assets (e.g., an entity that operates the platform 102, an entity that operates the custody system, etc.). The platform 102 then allocates such rewards to owners of UATs based on ownership information recorded in the ledger 121, and information identifying assets (and corresponding weights) for each owned UAT. Since different UAT sub-tokens have different sets of underlying assets, or different weights for the underlying assets, different UAT sub-tokens provide different rewards, even if they track the same primary asset. Rewards can be provided to UAT owner in the form of fiat, additional UAT, stablecoin, or in any other suitable form of asset or currency. In a second example, no additional UATs (or UAT sub-tokens) can be issued to the user in response to asset splits (e.g., in variants where the UAT asset set is determined based on asset proportion, not asset units), but the value of the UAT or UAT sub-token can increase. In a third example, additional UATs (or UAT sub-tokens) can be issued to the user in response to asset splits (e.g., proportional to the asset split). However, rewards can be otherwise managed.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising: with a computing platform:
accessing historic values of a primary asset and each of a plurality of secondary assets over a time period;
selecting a plurality of universal access token (UAT) asset sets for the primary asset, wherein each UAT asset set includes the primary asset and a set of one or more of the secondary assets whose change in combined value over the time period correlates with change in the value of the primary asset over the time period, as indicated by the accessed historic values;
with a blockchain trading system, receiving a first buy request to buy a first amount of a UAT for the primary asset on behalf of a first user of the platform;
in response to the first buy request, selecting a first one of the UAT asset sets for the primary asset, based on the first user's transaction history for the UAT for the primary asset;
with a UAT smart contract, minting the first amount of a first UAT that represents ownership of the selected first UAT asset set;
with the trading system, executing a first buy transaction for the minted first UAT; and
updating the first user's transaction history for the UAT for the primary asset to include a record of the first buy transaction.

2. The method of claim 1, wherein selecting a first one of the UAT asset sets for the primary asset comprises:
ranking the plurality of UAT asset sets according to respective correlation metrics that identify correlation with the primary asset; and
identifying the UAT asset sets that have not been sold on behalf of the first user within a predetermined time period, as identified by the first user's transaction history for the UAT for the primary asset; and
selecting the identified UAT asset set that has the highest correlation metric.

3. The method of claim 1, further comprising, with the platform:
purchasing the assets of the first UAT asset set by using an asset trading system; and
securing the purchased assets by using a custody system.

4. The method of claim 3, further comprising: with the platform;
determining weights for the assets of the first UAT asset set,
wherein the assets for the first UAT asset set are purchased in accordance with the weights.

5. The method of claim 4, wherein determining weights for the assets of the first UAT asset set comprises: selecting a maximum weight value for the primary asset.

6. The method of claim 5, wherein the maximum weight value for the primary asset is identified by tax law information related to tax loss harvesting.

7. The method of claim 1, further comprising: with the platform:
creating at least one new UAT asset set for the primary asset,
wherein creating a new UAT asset set for the primary asset comprises at least one of:
adding a new asset to an existing UAT asset set, or
changing at least one asset weight of an existing UAT asset set.

8. The method of claim 1, further comprising, with the platform:
providing the first user with rewards associated with the assets of the first UAT.

9. The method of claim 1, further comprising:
with the blockchain trading system, receiving a second buy request to buy a second amount of the UAT for the primary asset on behalf of the first user;
in response to the second buy request, selecting a second UAT associated with a second UAT asset set for the primary asset, based on a transaction history of the first user for the UAT for the primary asset;
with the trading system, executing a second buy transaction for the second UAT; and
updating the first user's transaction history for the UAT for the primary asset to include a record of the second buy transaction.

10. The method of claim 9, further comprising: with an asset management system, automatically providing a first sell request to sell the first UAT and the second buy request to the blockchain trading system during processing of a tax loss harvesting operation.

11. The method of claim 9, wherein the second UAT asset set differs from the first UAT asset set in at least one of: asset weight, asset type, or asset identifier.

12. The method of claim 11, wherein the second UAT asset set and the first UAT asset set include different secondary assets.

13. The method of claim 11, wherein the second UAT asset set and the first UAT asset set include different weights for the same secondary assets.

14. A method comprising: with a computing platform:
with a blockchain trading system, receiving a first buy request to buy a first amount of a Universal Access Token (UAT) for a primary asset on behalf of a first user of the platform, and updating the first user's transaction history for the UAT for the primary asset to include a record of a first buy request;
with the blockchain trading system, receiving from an asset management system a first sell request to sell the first amount of the UAT for the primary asset on behalf of the first user and a second buy request to buy back the first amount of the UAT for the primary asset;
in response to completion of processing of the first sell request:
selecting a UAT asset set for the primary asset, based on the first user's transaction history for the UAT for the primary asset;
with a UAT smart contract, minting the first amount of a first UAT that represents ownership of the selected first UAT asset set;
with the trading system, executing a first buy transaction for the minted first UAT; and
updating the first user's transaction history for the UAT for the primary asset to include a record of the second buy request.

15. A method, comprising:
automatically detecting a first event; and
in response to first event detection, automatically:
transferring a first universal asset token (UAT) sub-token out of a user account; and
transferring a second UAT sub-token into the user account, wherein the second UAT sub-token is not substantially identical to the first UAT sub-token but tracks a common metric with the first UAT sub-token;
wherein the first and second UAT sub-tokens are cryptocurrency tokens.

16. The method of claim 15, wherein the first event comprises a value of the first UAT sub-token decreasing below a first threshold.

17. The method of claim 15, wherein the common metric comprises a primary asset.

18. The method of claim 17, wherein the first UAT sub-token is backed by a first UAT asset set comprising a first asset composition, and the second UAT sub-token is backed by a second UAT asset set comprising a different asset composition from the first asset composition.

19. The method of claim 18, wherein the second UAT sub-token was not transferred out of the user account within a predetermined time period prior to transferring the second UAT sub-token into the user account.

20. The method of claim 15, wherein transferring the first UAT sub-token out of the user account and transferring the second UAT sub-token into the user account is logged in an off-chain ledger.
